(19) United States
(12) Patent Application Publication
(10) Pub. No.: US 2006/0280344 A1
(43) Pub. Date: Dec. 14, 2006

(54) Illumination normalizing apparatus, method, and medium and face recognition apparatus, method, and medium using the illumination normalizing apparatus, method, and medium

(75) Inventors: Seokcheol Kee, Seoul (KR); Yangsheng Wang, Beijing (CN)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/447,993

(22) Filed: Jun. 7, 2006

(30) Foreign Application Priority Data
Jun. 13, 2005 (KR) 10-2005-0050496

(51) Int. Cl. G06K 9/00; G06K 9/40

(52) U.S. Cl. 382/118; 382/274

(57) ABSTRACT

An illumination normalizing apparatus, method, and medium and a face recognition apparatus, method, and medium using the illumination normalizing apparatus, method, and medium are provided. The illumination normalizing apparatus comprises a basis vector generation unit which generates a plurality of basis vectors to represent a plurality of illumination conditions of each of a plurality of face images included in a training set, an illumination normalizing coefficient obtaining unit which obtains an illumination normalizing coefficient from a first face image using the basis vectors, and an illumination-normalized image obtaining unit which obtains an illumination-normalized image from a second face image using the basis vectors and the illumination normalizing coefficient.

### CROSS-REFERENCE TO RELATED APPLICATIONS

This application claims the benefit of Korean Patent Application No. 10-2005-0050496, filed on 13 Jun. 2005, in the Korean Intellectual Property Office, the disclosure of which is incorporated herein in its entirety by reference.

### BACKGROUND OF THE INVENTION

1. Field of the Invention

The present invention relates to face recognition, and more particularly, to an illumination normalizing apparatus, method, and medium in which illumination conditions of each of a plurality of images registered with a registration database are normalized to be the same as illumination conditions of an input image and then a match for the input image is searched for from the registration database, and a face recognition apparatus, method, and medium using the illumination normalizing apparatus, method, and medium.

2. Description of the Related Art

Recently, various living-body recognition techniques for authenticating individuals based on the physical or behavioral characteristics of individuals have been developed. Conventional authentication tools, such as passwords or ID cards, require users to memorize or carry them and always face the risk of being exposed to or stolen by unauthorized third persons. On the other hand, biometric identification uses various parts of the human body and thus does not have the inconvenience and risks associated with conventional authentication tools. In biometric identification, various physical or behavioral characteristics of an individual, such as the face, the iris, the retina, the palm of the hand, the pattern of blood vessels on the back of the hand, fingerprints, signatures, handwriting, typing and keyboard style, and walking style, are used.

Biometric identification apparatuses based on face recognition, in particular, can identify an individual from a distance using a camera without requiring the individual to put their fingers on an input module and are relatively cheap. However, conventional face recognition-based biometric identification apparatuses are not suitable yet for user authentication because they may incorrectly identify the face of a person due to variations in illumination and the person's posture, changes in the face of the person as a result of aging or cosmetic surgery and according to whether the person is wearing makeup or in disguise and thus may not be able to guarantee as high user authentication rates as biometric apparatuses based on fingerprint recognition or iris recognition. The performance of conventional face recognition-based biometric identification apparatuses may be worse in outdoor settings than in indoor settings because of drastic changes in illumination.

In order to solve the problems of conventional face recognition-based biometric identification techniques, face recognition techniques which are relatively robust to variations in illumination have been developed. However, these face recognition techniques are not yet suitable for providing satisfactory authentication rates in variable illumination conditions especially when an image to be authenticated is a face image with a large shadow.

### SUMMARY OF THE INVENTION

Additional aspects, features, and/or advantages of the invention will be set forth in part in the description which follows and, in part, will be apparent from the description, or may be learned by practice of the invention.

The present invention provides an illumination normalizing apparatus and method in which illumination conditions for each of a plurality of images registered with a registration database are normalized to be the same as illumination conditions for an input image to be authenticated regardless of what the illumination conditions for the input image to be authenticated are.

The present invention also provides a face recognition apparatus, method, and medium in which illumination conditions of each of a plurality of images registered with a registration database are normalized to be the same as illumination conditions of an input image and then a match for the input image is searched for from the registration database.

According to an aspect of the present invention, there is provided an illumination normalizing apparatus comprising: a basis vector generation unit which generates a plurality of basis vectors to represent a plurality of illumination conditions of each of a plurality of face images included in a training set; an illumination normalizing coefficient obtaining unit which obtains an illumination normalizing coefficient from a first face image using the basis vectors; and an illumination-normalized image obtaining unit which obtains an illumination-normalized image from a second face image using the basis vectors and the illumination normalizing coefficient.

According to another aspect of the present invention, there is provided an illumination normalizing method comprising: generating a plurality of basis vectors to represent a plurality of illumination conditions of each of a plurality of face images included in a training set; obtaining an illumination normalizing coefficient from a first face image using the basis vectors; and obtaining an illumination-normalized image from a second face image using the basis vectors and the illumination normalizing coefficient.

According to still another aspect of the present invention, there is provided a face recognition apparatus comprising: a basis vector generation unit which generates a plurality of basis vectors to represent a plurality of illumination conditions of each of a plurality of face images included in a training set; an illumination normalizing unit which generates an illumination-normalized image from a second face image using an illumination normalizing coefficient which is obtained from a first face image using the basis vectors; and a matching unit which matches the illumination-normalized image with the first face image.

According to yet still another aspect of the present invention, there is provided a face recognition method comprising: generating a plurality of basis vectors which can represent a plurality of illumination conditions of each of a plurality of face images included in a training set; generating an illumination-normalized image from a second face image using an illumination normalizing coefficient which is obtained from a first face image using the basis vectors; and matching the illumination-normalized image with the first face image.

According to a further aspect of the present invention, there is provided a computer-readable recording medium storing a computer program for executing an illumination normalizing method or a face recognition method.

According to another aspect of the present invention, there is provided at least one computer-readable medium storing instructions that control at least one processor for executing an illumination normalizing method, the illumination normalizing method including generating a plurality of basis vectors which can represent a plurality of illumination conditions of each of a plurality of face images included in a training set; obtaining an illumination normalizing coefficient from a first face image using the basis vectors; and obtaining an illumination-normalized image from a second face image using the basis vectors and the illumination normalizing coefficient.

According to another aspect of the present invention, there is provided at least one computer-readable recording medium storing instructions that control at least one processor for executing a face recognition method, the face recognition method including generating a plurality of basis vectors which can represent a plurality of illumination conditions of each of a plurality of face images included in a training set; generating an illumination-normalized image from a second face image using an illumination normalizing coefficient which is obtained from a first face image using the basis vectors; and matching the illumination-normalized image with the first face image.

According to another aspect of the present invention, there is provided an illumination normalizing method including obtaining an illumination normalizing coefficient from a first face image using a plurality of basis vectors; and obtaining an illumination-normalized image from a second face image using the basis vectors and the illumination normalizing coefficient.

According to another aspect of the present invention, there is provided a face recognition method including generating an illumination-normalized image from a second face image using an illumination normalizing coefficient which is obtained from a first face image using basis vectors; and matching the illumination-normalized image with the first face image.

According to another aspect of the present invention, there is provided at least one computer-readable medium storing instructions that control at least one processor for executing an illumination normalizing method, the illumination normalizing method including obtaining an illumination normalizing coefficient from a first face image using a plurality of basis vectors; and obtaining an illumination-normalized image from a second face image using the basis vectors and the illumination normalizing coefficient.

According to another aspect of the present invention, there is provided at least one computer-readable recording medium storing instructions that control at least one processor for executing a face recognition method, the face recognition method including generating an illumination-normalized image from a second face image using an illumination normalizing coefficient which is obtained from a first face image using basis vectors; and matching the illumination-normalized image with the first face image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram of a face recognition apparatus according to an exemplary embodiment of the present invention;

FIG. 2 is a detailed block diagram of an illumination normalizing unit of FIG. 1 according to an exemplary embodiment of the present invention;

FIG. 3 is a diagram illustrating an illumination normalizing coefficient obtained by an illumination normalizing coefficient obtaining unit of FIG. 2;

FIG. 4 is a diagram for explaining a method of generating various face images under different illumination conditions using illumination normalizing coefficients; and

FIG. 5 is a flowchart illustrating a face recognition method according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

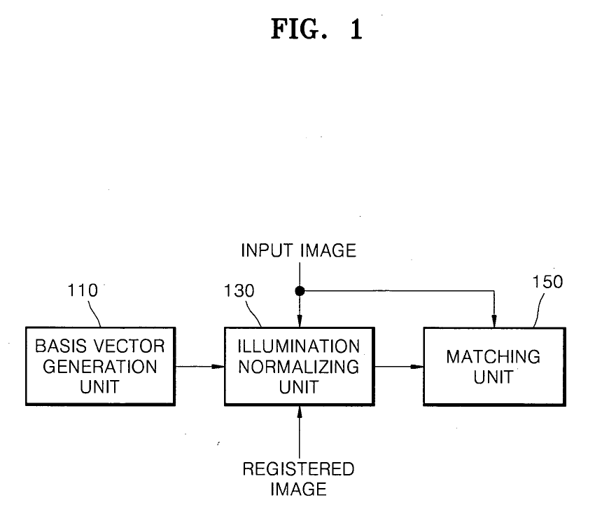

FIG. 1 is a block diagram of a face recognition apparatus according to an exemplary embodiment of the present invention. Referring to FIG. 1, the face recognition apparatus includes a basis vector generation unit 110, an illumination normalizing unit 130, and a matching unit 150.

The basis vector generation unit 110 establishes a global illumination subspace for a training set, which comprises a plurality of face images obtained from various individuals under various illumination conditions and projects the training set onto the global illumination subspace, thereby obtaining a plurality of basis vectors E which can represent all of the different illumination conditions. Here, the basis vectors E can be obtained using various subspace techniques, such as principal component analysis (PCA), independent component analysis (ICA), and linear discriminant analysis (LDA).

The illumination normalizing unit 130 calculates first and second image representation coefficients X_{A} and X_{B} for first and second face images I_{A} and I_{B}, respectively, using the basis vectors E obtained by the basis vector generation unit 110. Here, the first and second image representation coefficients X_{A} and X_{B} are coefficients used to obtain least square approximation representations EX_{A} and EX_{B} for the first and second face images I_{A} and I_{B}, respectively. Thereafter, an illumination normalizing coefficient Q_{A} for the first face image I_{A} is calculated based on the ratio of the first face image I_{A} to the least square approximation representation EX_{A}. Thereafter, an illumination-normalized image I_{N} of the second face image I_{B} is obtained using the illumination normalizing coefficient Q_{A} as indicated by the following equation: I_{N}=Q_{A}EX_{B}. Here, the first face image I_{A} is an input image to be recognized or authenticated or a query image, and the second face image I_{B} is an image registered with a registration database (not shown). Illumination conditions for the illumination-normalized image I_{N}, obtained from the second face image I_{B} through illumination normalization performed by the illumination normalizing unit 130, are almost the same as illumination conditions for the first face image I_{A}.

The matching unit 150 matches the illumination-normalized image I_{N} with the first face image I_{A} through, for example, PCA, ICA, or LDA. A matching score obtained as a result of the matching process may be provided to an image searching unit (not shown), an authentication unit (not shown), or a recognition unit (not shown).

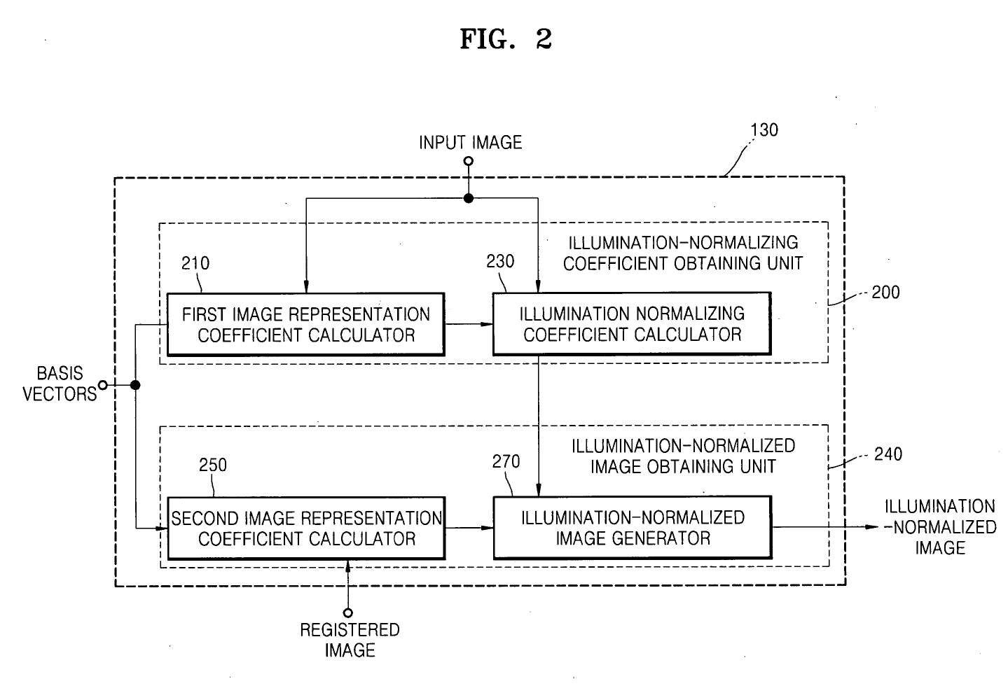

FIG. 2 is a detailed block diagram of the illumination normalizing unit 130 of FIG. 1 according to an exemplary embodiment of the present invention. Referring to FIG. 2, the illumination normalizing unit 130 includes an illumination normalizing coefficient obtaining unit 200 and an illumination-normalized image obtaining unit 240. The illumination normalizing coefficient obtaining unit 200 includes a first image representation coefficient calculator 210 and an illumination normalizing coefficient calculator 230. The illumination-normalized image obtaining unit 240 includes a second image representation coefficient calculator 250 and an illumination-normalized image generator 270.

The illumination normalizing coefficient obtaining unit 200 calculates an illumination normalizing coefficient for a first face image using a plurality of basis vectors obtained by the basis vector generation unit 110. In detail, the first face representation coefficient calculator 210 calculates a first face representation coefficient for the first face image using the basis vectors E. The illumination normalizing coefficient calculator 230 calculates an illumination normalizing coefficient based on the basis vectors E, the first face representation coefficient, and the first face image.

The illumination-normalized image obtaining unit 240 calculates an illumination-normalized image for a second face image using the basis vectors E obtained by the basis vector generation unit 110 and the illumination normalizing coefficient obtained by the illumination normalizing coefficient obtaining unit 200. In detail, the second face representation coefficient calculator 250 calculates a second face representation coefficient for the second face image using the basis vectors E. The illumination-normalized image generator 270 generates the illumination-normalized image for the second face image based on the basis vectors E, the second face representation coefficient, and the illumination normalizing coefficient.

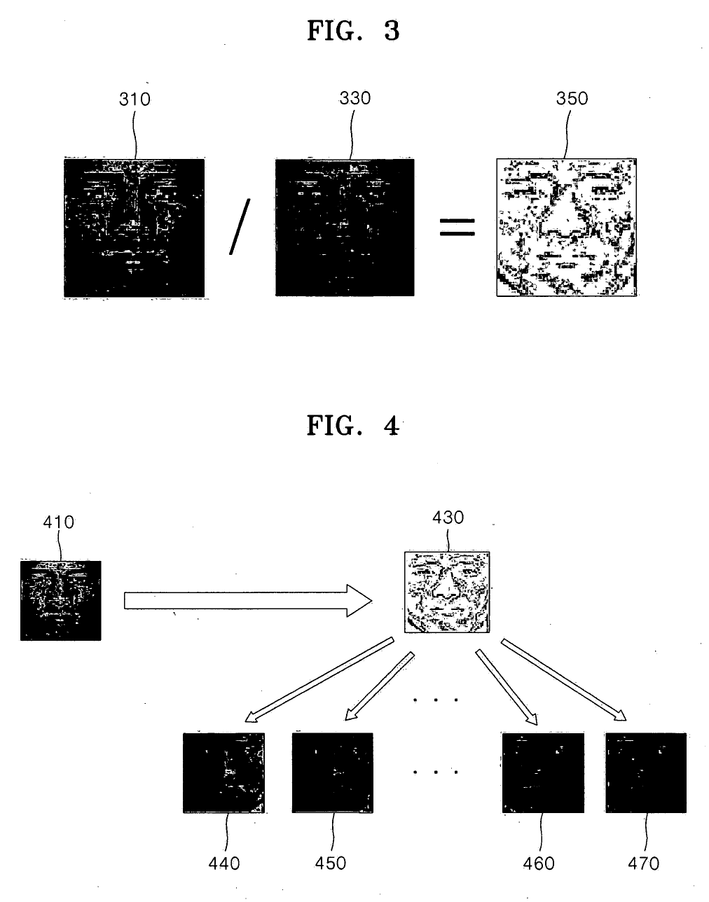

FIG. 3 is a diagram illustrating the illumination normalizing coefficient obtained by the illumination normalizing coefficient obtaining unit 200 of FIG. 2. In FIG. 3, reference numeral 310 indicates an input image to be authenticated or recognized (i.e., a reference image), reference numeral 330 indicates a least square approximation representation obtained from the reference image 310 using an image representation coefficient for the reference image 310, and reference numeral 350 indicates the ratio of the reference image 310 to the least square approximation representation 330, i.e., an illumination normalizing coefficient for the reference image.

FIG. 4 is a diagram for explaining a method of generating various face images under different illumination conditions using illumination normalizing coefficients. In FIG. 4, reference numeral 410 indicates a reference image, reference numeral 430 indicates an illumination normalizing coefficient obtained from the reference image 410, and reference numerals 440 through 470 indicate a plurality of face images under various illumination conditions obtained using the illumination normalizing coefficient 430 and a plurality of image representation coefficients.

Referring to FIG. 4, when an arbitrary reference image is used, the ratio of the arbitrary reference image to a least square approximation representation obtained from the arbitrary reference image, i.e., an illumination normalizing coefficient, is calculated as illustrated in FIG. 3, and a plurality of reference images under different illumination conditions are obtained by synthesizing the illumination normalizing coefficient and a plurality of image representation coefficients.

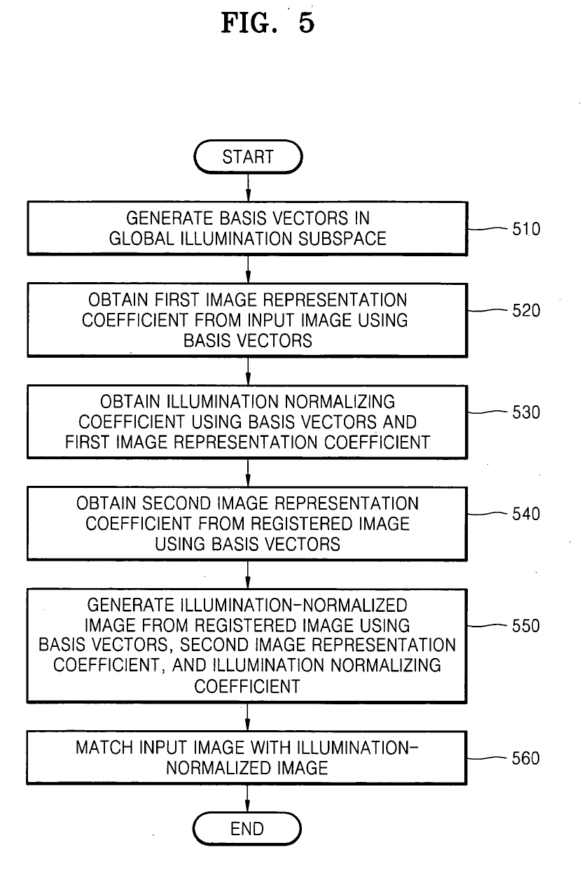

FIG. 5 is a flowchart illustrating a face recognition method according to an exemplary embodiment of the present invention. Referring to FIG. 5, in operation 510, a global illumination subspace is established for a training set, which comprises a plurality of face images obtained from various individuals under various illumination conditions, and the training set is projected onto the global illumination subspace, thereby obtaining a plurality of basis vectors E which can represent a plurality of illumination conditions. The sizes and illumination conditions of the face images included in the training set can be normalized, and then the normalization results can be configured using a typical face configuration technique, such as an active shape model (ASM) technique.

In operation 520, a first image representation coefficient x_{A} used to obtain a least square approximation representation Iₐ of an input image I_{A}, using the basis vectors E obtained in operation 510. In other words, the least square approximation representation Iₐ in the illumination subspace can be represented by a linear combination of the first image representation coefficient X_{A} and the basis vectors E as indicated in Equation (1):
Iₐ=EX_{A} (1)

In operation 530, an illumination normalizing coefficient Q_{A} is obtained from the input image I_{A} using the basis vectors E obtained in operation 510 and the first image representation coefficient x_{A}. Operation 530 will now be described in further detail.

In an image model, a human face can be processed as a Lambertian surface. Therefore, an arbitrary face image I(x, y) can be represented by Equation (2):
I(x, y)=ρ(x, y)n(x, y)^{T}S (2)
where (x, y) is a point on the arbitrary face image I(x, y), ρ(x, y) is an albedo (i.e., a reflection coefficient of the surface of the face in the arbitrary face image I(x, y)), n(x, y)^{T} is a 3-dimensional (3D) normal vector on the surface of the face in the arbitrary face image I(x, y), and s indicates a direction in which light emitted from an illumination source is incident upon the surface of the face in the arbitrary face image I(x, y). The albedo ratio between two face images I₂ and Iₐ obtained from different individuals, i.e.,

$$\frac{{ρ}_{y} ( u , v )}{{ρ}_{a} ( u , v )} ,$$

remains constant regardless of the variation in illumination and thus can be used as an illumination normalizing coefficient for the face image I_{y}.

In the meantime, the albedo ratio between face images I_{y} and Iₐ obtained from the same individual can be represented by Equation (3):

$$\frac{{ρ}_{y} ( u , v )}{{ρ}_{a} ( u , v )} = \frac{{ρ}_{y} ( u , v ) {n ( u , v )}^{T} {s}_{y}}{{ρ}_{a} ( u , v ) n {( u , v )}^{T} {s}_{y}} = \frac{{I}_{y}}{{ρ}_{a} ( u , v ) {n ( u , v )}^{T} {s}_{y}} = \frac{{I}_{y}}{{I}_{a}} \qquad ( 3 )$$

Here, the 3D shape of the face included in the face image Iₐ is similar to the shape of the face included in the face image I_{y}, and illumination conditions for the face image Iₐ are similar to illumination conditions for the face image I_{y}. Therefore, the albedo ratio can be converted into an image ratio between the two face images Iₐ and I_{y} having different albedos and similar 3D shape and illumination conditions.

Accordingly, the albedo ratio between the input image I_{A} and the least square approximation representation Iₐ of the input image I_{A}, i.e., the illumination normalizing coefficient Q_{A}, can be defined by Equation (4):

$${Q}_{A} = \frac{{I}_{A}}{{I}_{a}} = \frac{{I}_{A}}{{Ex}_{A}} \qquad ( 4 )$$

M images registered with a registration database (not shown) can be illumination-normalized using the illumination normalizing coefficient Q_{A}, thus obtaining M illumination-normalized images having the same illumination conditions as the input image I_{A}, as indicated in Equation (5):

$${I}_{new} = {\sum }_{i = 1}^{M} {x}_{i} {E}_{i} ⊗ {Q}_{A} \qquad ( 5 )$$

where I_{new} is an image obtained by illumination-normalizing a registered image Iᵢ to have the same illumination conditions as the input image I_{A}, and xᵢ is an image representation coefficient which is used for obtaining a least square approximation representation from the registered image Iᵢ.

In operation 540, a second image representation coefficient x_{B}, which is used for obtaining a least square approximation representation I_{b} from a registered image I_{B}, is obtained using the basis vectors E obtained in operation 510. The least square approximation representation I_{b} of the registered image I_{B} in the illumination subspace can be defined by Equation (6):
I_{b}=Ex_{B} (6).

In operation 550, an illumination-normalized image I_{N} for the registered image I_{B} is generated using the basis vectors E obtained in operation 510, the illumination normalization coefficient Q_{A} obtained in operation 530, and the second image representation coefficient x_{B} obtained in operation 540. The illumination-normalized image I_{N} can be represented by Equation (7):
I_{N}=Q_{A}Ex_{B} (7).

The illumination-normalized image I_{N} obtained from the registered image I_{B} has the same illumination conditions as the input image I_{A}.

In operation 560, the input image I_{A} is matched with the illumination-normalized image I_{N}.

Hereinafter, Table 1 below presents face recognition results obtained by applying the face recognition method according to an exemplary embodiment of the present invention and two conventional face recognition methods, i.e., a direct correlation method and a quotient method to a Pose, Illumination, and Expression (PIE) face recognition face image database.

TABLE 1

| | Direct | | Exemplary Embodiment of |
|---|---|---|---|
| | Correlation | Quotient | Present Invention |
| Subset 1 | 97% | 91.4% | 100% |
| Subset 2 | 57% | 45.8% | 92% |

Here, Subset 1 comprises a plurality of face images with no shadows, and Subset 2 comprises a plurality of face images with large shadows. Referring to Table 1, the performance of the face recognition method according to an exemplary embodiment of the present invention is much better than those of the direct correlation method and the quotient method, especially when applied to Subset 2.

In addition to the above-described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code/instructions can be recorded/transferred in/on a medium in a variety of ways, with examples of the medium including magnetic storage media (e.g., floppy disks, hard disks, magnetic tapes, etc.), optical recording media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include instructions, data structures, etc. Examples of storage/transmission media may include wired and/or wireless transmission (such as transmission through the Internet). Examples of wired storage/transmission media may include optical wires and metallic wires. The medium/media may also be a distributed network, so that the computer readable code/instructions is stored/transferred and executed in a distributed fashion. The computer readable code/instructions may be executed by one or more processors.

As described above, according to the present invention, it is possible to guarantee a high face recognition or authentication rate for an input image regardless of the illumination conditions of the input image by normalizing each of a plurality of images registered with a registration database to have the same normalization conditions as the input image and matching the normalization results with the input image.

Although several exemplary embodiments of the present invention have been described, it would be appreciated by those skilled in the art that changes may be made in these exemplary embodiments without departing from the principles and spirit of the invention, the scope of which is defined in the claims and their equivalents.

What is claimed is:

1. An illumination normalizing apparatus comprising:
a basis vector generation unit which generates a plurality of basis vectors to represent a plurality of illumination conditions of each of a plurality of face images included in a training set;
an illumination normalizing coefficient obtaining unit which obtains an illumination normalizing coefficient from a first face image using the basis vectors; and
an illumination-normalized image obtaining unit which obtains an illumination-normalized image from a second face image using the basis vectors and the illumination normalizing coefficient.

2. The illumination normalizing apparatus of claim 1, wherein the basis vectors are obtained using a subspace method.

3. The illumination normalizing apparatus of claim 1, wherein the illumination normalizing coefficient obtaining unit comprises:
a first face representation coefficient calculator which calculates a first face representation coefficient for the first face image using the basis vectors; and
an illumination normalizing coefficient calculator which calculates the illumination normalizing coefficient from the first face image using the basis vectors and the first face representation coefficient.

4. The illumination normalizing apparatus of claim 1, wherein the illumination-normalized image obtaining unit comprises:
a second face representation coefficient calculator which calculates a second face representation coefficient for the second face image using the basis vectors; and
an illumination-normalized image generator which generates the illumination-normalized image for the second face image using the basis vectors, the second face representation coefficient, and the illumination normalizing coefficient.

5. The illumination normalizing apparatus of claim 1, wherein the illumination normalizing coefficient is an albedo ratio between the first face image and a least square approximation representation of the first face image.

6. An illumination normalizing method comprising:
generating a plurality of basis vectors to represent a plurality of illumination conditions of each of a plurality of face images included in a training set;
obtaining an illumination normalizing coefficient from a first face image using the basis vectors; and
obtaining an illumination-normalized image from a second face image using the basis vectors and the illumination normalizing coefficient.

7. The illumination normalizing method of claim 6, wherein the generation of the basis vectors comprises generating the basis vectors using a subspace method.

8. The illumination normalizing method of claim 6, wherein the obtaining of the illumination normalizing coefficient comprises:
calculating a first face representation coefficient for the first face image using the basis vectors; and
calculating the illumination normalizing coefficient from the first face image using the basis vectors and the first face representation coefficient.

9. The illumination normalizing method of claim 6, wherein the obtaining of the illumination-normalized image comprises:
calculating a second face representation coefficient for the second face image using the basis vectors; and
generating the illumination-normalized image for the second face image using the basis vectors, the second face representation coefficient, and the illumination normalizing coefficient.

10. The illumination normalizing method of claim 6, wherein the illumination normalizing coefficient is an albedo ratio between the first face image and a least square approximation representation of the first face image.

11. A face recognition apparatus comprising:
a basis vector generation unit which generates a plurality of basis vectors to represent a plurality of illumination conditions of each of a plurality of face images included in a training set;
an illumination normalizing unit which generates an illumination-normalized image from a second face image using an illumination normalizing coefficient which is obtained from a first face image using the basis vectors; and
a matching unit which matches the illumination-normalized image with the first face image.

12. The face recognition apparatus of claim 11, wherein the illumination normalizing unit comprises:
an illumination normalizing coefficient obtaining unit which obtains the illumination normalizing coefficient from the first face image using the basis vectors; and
an illumination-normalized image obtaining unit which obtains the illumination-normalized image from the second face image using the basis vectors and the illumination normalizing coefficient.

13. The face recognition apparatus of claim 11, wherein the illumination normalizing coefficient obtaining unit comprises:
a first face representation coefficient calculator which calculates a first face representation coefficient for the first face image using the basis vectors; and
an illumination normalizing coefficient calculator which calculates the illumination normalizing coefficient from the first face image using the basis vectors and the first face representation coefficient.

14. The face recognition apparatus of claim 11, wherein the illumination-normalized image obtaining unit comprises:
a second face representation coefficient calculator which calculates a second face representation coefficient for the second face image using the basis vectors; and
an illumination-normalized image generator which generates the illumination-normalized image for the second face image using the basis vectors, the second face representation coefficient, and the illumination normalizing coefficient.

15. The face recognition apparatus of claim 11, wherein the illumination normalizing coefficient is an albedo ratio between the first face image and a least square approximation representation of the first face image.

16. A face recognition method comprising:
generating a plurality of basis vectors which can represent a plurality of illumination conditions of each of a plurality of face images included in a training set;
generating an illumination-normalized image from a second face image using an illumination normalizing coefficient which is obtained from a first face image using the basis vectors; and
matching the illumination-normalized image with the first face image.

17. The face recognition method of claim 16, wherein the obtaining of the illumination normalizing coefficient comprises:
obtaining the illumination normalizing coefficient from the first face image using the basis vectors; and
obtaining the illumination-normalized image from the second face image using the basis vectors and the illumination normalizing coefficient.

18. The face recognition method of claim 16, wherein the obtaining of the illumination normalizing coefficient comprises:
calculating a first face representation coefficient for the first face image using the basis vectors; and
calculating the illumination normalizing coefficient from the first face image using the basis vectors and the first face representation coefficient.

19. The face recognition method of claim 16, wherein the generation of the illumination-normalized image comprises:
calculating a second face representation coefficient for the second face image using the basis vectors; and
generating the illumination-normalized image for the second face image using the basis vectors, the second face representation coefficient, and the illumination normalizing coefficient.

20. The face recognition method of claim 16, wherein the illumination normalizing coefficient is an albedo ratio between the first face image and a least square approximation representation of the first face image.

21. At least one computer-readable medium storing instructions that control at least one processor for executing an illumination normalizing method, the illumination normalizing method comprising:
generating a plurality of basis vectors which can represent a plurality of illumination conditions of each of a plurality of face images included in a training set;
obtaining an illumination normalizing coefficient from a first face image using the basis vectors; and
obtaining an illumination-normalized image from a second face image using the basis vectors and the illumination normalizing coefficient.

22. At least one computer-readable recording medium storing instructions that control at least one processor for executing a face recognition method, the face recognition method comprising:
generating a plurality of basis vectors which can represent a plurality of illumination conditions of each of a plurality of face images included in a training set;
generating an illumination-normalized image from a second face image using an illumination normalizing coefficient which is obtained from a first face image using the basis vectors; and
matching the illumination-normalized image with the first face image.

23. An illumination normalizing method comprising:
obtaining an illumination normalizing coefficient from a first face image using a plurality of basis vectors; and
obtaining an illumination-normalized image from a second face image using the basis vectors and the illumination normalizing coefficient.

24. The illumination normalizing method of claim 23, further comprising generating the basis vectors to represent a plurality of illumination conditions of each of a plurality of face images.

25. A face recognition method comprising:
generating an illumination-normalized image from a second face image using an illumination normalizing coefficient which is obtained from a first face image using basis vectors; and
matching the illumination-normalized image with the first face image.

26. The face recognition method of claim 25, further comprising generating the basis vectors to represent a plurality of illumination conditions of each of a plurality of face images.

27. At least one computer-readable medium storing instructions that control at least one processor for executing an illumination normalizing method, the illumination normalizing method comprising:
obtaining an illumination normalizing coefficient from a first face image using a plurality of basis vectors; and
obtaining an illumination-normalized image from a second face image using the basis vectors and the illumination normalizing coefficient.

28. At least one computer-readable recording medium storing instructions that control at least one processor for executing a face recognition method, the face recognition method comprising:
generating an illumination-normalized image from a second face image using an illumination normalizing coefficient which is obtained from a first face image using basis vectors; and
matching the illumination-normalized image with the first face image.
